(19) United States
(12) Patent Application Publication
(10) Pub. No.: US 2026/0365181 A1
(43) Pub. Date: Nov. 19, 2026

(54) CONTROL FOR VEHICLES AND/OR ROBOTS WITH IMPROVED CONSIDERATION OF UNCERTAINTIES

(71) Applicant: Robert Bosch GmbH, Stuttgart (DE)

(72) Inventors: Joerg Wagner, Renningen (DE); Andreas Look, Wiesengiech (DE); Denesh Kumar Manivannan, Ludwigsburg (DE); Faris Janjos, Stuttgart (DE); Ilya Kamenshchikov, Aachen (DE); Jean-Marc Montanier, Stuttgart (DE); Nils Oliver Ferguson, Weil Der Stadt - Merklingen (DE)

(21) Appl. No.: 19/661,192

(22) Filed: Apr. 28, 2026

(30) Foreign Application Priority Data
May 14, 2025 (DE) 10 2025 118 561.1

(51) Int. Cl. B60W 50/00; B60W 60/00; G05B 13/02

(52) U.S. Cl. CPC B60W 50/0097; B60W 60/0015; B60W 60/0053; G05B 13/0265

(57) ABSTRACT

A system for controlling a vehicle and/or robot. The system includes at least one perception module that processes one or more sensor signals, acquired by at least one sensor carried by the vehicle and/or robot, using a trainable or trained machine learning model to produce a perception output. The system is designed to ascertain a control signal for at least one actuator of the vehicle and/or robot using the perception output, and to control the actuator with said control signal. The perception output includes information that characterizes a distribution of possible values of at least one perception output variable, and the perception output variable describes at least one partial aspect of the current situation that the vehicle and/or the robot is in.

### FIELD

The present disclosure relates to the automated control of vehicles and/or robots, in particular for movement on company premises or in public traffic.

### BACKGROUND INFORMATION

Systems for the automated control of vehicles and/or robots obtain sensor data from monitoring the surroundings of the vehicle and/or robot and, in a complex process, ascertain control signals therefrom that influence the future behavior of the vehicle and/or robot.

Processing the sensor data into control signals typically takes place in a chain of three modules: a perception module, a prediction module and a planning module. The perception module ascertains the current situation that the vehicle and/or the robot is in. The prediction module predicts how this situation will develop in the future. The planning module ascertains, on the basis of this prediction, a desired and/or required future behavior of the vehicle and/or robot. Since the processing chain is consistently differentiable across the three modules, detected errors in the ultimately proposed actions can be propagated back to all participating modules. This therefore allows for a comprehensive “end-to-end training” of all modules.

### SUMMARY

The present disclosure provides a system for controlling a vehicle and/or robot. This system is designed to ascertain a control signal for at least one actuator of the vehicle and/or robot from sensor signals acquired by at least one sensor carried by the vehicle and/or robot, and to control the actuator with said control signal. In detail, the system comprises at least one perception module that processes the sensor signals into a perception output using a trainable or trained machine learning model.

A trainable machine learning model in particular refers to a model that embodies a function that is parameterized with adjustable parameters and has great power to generalize. During training, the parameters may be adapted, in particular, in such a manner that, in response to inputting input variable learning values into the model, the corresponding output variable learning values are reproduced as effectively as possible. The trainable machine learning model can in particular include an artificial neural network (ANN) and/or a support vector machine (SVM), and/or it can be an ANN or an SVM.

The phrase “trainable or trained” means that the machine learning model always produces an output of the type mentioned, regardless of whether it has already been trained or not. But in the untrained state, the output does not reflect the reality as well as it does in the already trained state. In other words, even if the relevant machine learning model is not yet fully trained, the system is already a system whose corresponding module is configured for ascertaining the intended output in each case.

The sensor signals can be of any modality. For example, monitoring the surroundings of vehicles usually involves the use of one or more cameras that record moving or still images. Alternatively or in combination therewith, any measurement modalities can be used that, for example, provide point clouds as results. An image typically assigns a value, such as an intensity and/or color value, to each pixel in a two-or three-dimensional grid. A point cloud assigns one or more values, such as values of one or more measured variables, to any point in space. For example, radar measurements and lidar measurements provide point clouds.

The perception output comprises information that characterizes a distribution of possible values of at least one perception output variable. This perception output variable describes at least one partial aspect of the current situation that the vehicle and/or the robot is in.

It was found that, in this way, uncertainties in the perception output variable can be better taken into account and better processed by downstream modules, such as a prediction module or a planning module. In particular, knowledge acquired from any source that a perception may be subject to uncertainties can be used in further processing. If a prediction for future developments and subsequent planning of future behavior are ascertained on the basis of an uncertain perception, it can be avoided that the prediction or planning is only attributed the uncertainty inherent in its direct generation, and the uncertainty of the originally used intermediate product, namely perception, is ignored. The greatest uncertainties lie precisely in perception, in particular if the quality of the acquired sensor signals fluctuates. For example, darkness or bad weather can impair the image quality of a Camera system such that a distinction between certain classes of objects, which is no problem at all under good conditions, suddenly becomes almost impossible.

Furthermore, fluctuations in the perception output variable can be better tracked and processed. This is true in particular if the perception output variable is discrete, such as a class to which an object is assigned. Fluctuations in the associated softmax scores can, for example, lead to the class with the highest score initially being “motorcycle”, then “bicycle” and later “moped.” The class as a perception output variable can thus constantly oscillate between these three options. It is difficult to make meaningful calculations with a variable that changes in this way. A much better approach is a continuous distribution where the maximum shifts gradually.

This means that if one has to live with an uncertainty in the perception output variable anyway, one can completely forgo the output of a specific individual value and only calculate with distributions. This is advantageous in particular when further processing with a further machine learning model takes place, which can create further uncertainties as a result. Interactions between the various sources of uncertainty can then be taken into account much better. This is somewhat analogous to the fact that, in communications engineering, arbitrarily long chains of different amplifications and attenuations can be studied on the way from sender to receiver by simply adding and subtracting the respective decibels (dB). The final result obtained for the entire path then only needs to be multiplied by the transmission power to obtain the signal strength at the receiver's location.

Therefore, in a particularly advantageous example embodiment, the system comprises a prediction module to which the perception output is supplied. The prediction module uses a trainable or trained machine learning model to ascertain a prediction output. The system is designed to ascertain the control signal using said prediction output. The perception output is also still used to ascertain the control signal, however no longer directly, but rather in the form of the prediction output obtained therefrom.

In a further particularly advantageous example embodiment, the system comprises a planning module. Said planning module receives the prediction output as input and uses a trainable machine learning model to ascertain a planning output therefrom. The planning output refers to at least one planning output variable that describes a desired and/or required future behavior of the vehicle and/or robot. The system is designed to ascertain the control signal using said planning output. Analogous to what has been said before, both the perception output and the prediction output are still incorporated into the control signal, however only in the form of the further processing product.

The control signal can be generated from the planning output in any way. For example, the planning output can specify a trajectory to be followed by the vehicle and/or robot in the future, and according to any defined rule, it can be ascertained how following this trajectory is to be translated into control signals for the at least one actuator.

Particularly advantageously, the planning output also comprises information that characterizes a distribution of possible values of the planning output variable. The planning module can then have a similar architecture as the perception module and the prediction module. However, the planning output can also directly include a planning output variable that is closer to the ultimately sought-after control signal.

In a particularly advantageous example embodiment, at least one distribution specifies a probability density for values of the perception output variable, the prediction output variable, or the planning output variable. In this way, it is possible to directly read from the distribution which value is the most likely one in each case. At the same time, it is also evident how much the probability of this value differs from the probabilities of other values. If the absolute value of the probability for one value is high, but all other values are similarly likely, then the value with the highest probability is not particularly outstanding.

In a further particularly advantageous example embodiment, the probability density is a measure of the probability that an object of a certain class is located in the surroundings of the vehicle and/or robot. As explained above, further calculations can be performed much more effectively by gradually varying this probability or probability density than by using a selection that oscillates between different classes.

In a further particularly advantageous example embodiment, the perception output, the prediction output and/or the planning output comprises parameters of a parameterized distribution. The distribution can then already be qualitatively defined in each case such that a specific parameterized approach is used, while it is quantitatively ascertained by the relevant module.

In particular, the distribution can be, for example, a Gaussian distribution, a Laplace distribution, or a Bernoulli distribution. A Gaussian distribution is characterized by a mean value and a standard deviation. A Bernoulli distribution is characterized by a single probability value. For example, a Bernoulli distribution can be used to decide whether an object is or is not present at a specific location in the surroundings of the vehicle and/or robot. It can also be used, for example, to ascertain whether a lane branches off from a roadway to the right or not. In matters of this kind, too, the answer could so far oscillate between the two possibilities.

In a further particularly advantageous example embodiment, information that characterizes at least one distribution, such as parameters of a parameterized distribution, is assigned to at least one object in the surroundings of the vehicle and/or robot. This information can therefore be added additively to deterministic information and attributes that are already known for the objects. Downstream modules therefore have the free choice to use the known deterministic information and attributes or the newly ascertained non-deterministic information for a specific object.

In a further particularly advantageous example embodiment, the perception module, the prediction module and/or the planning module each have
an encoder that transfers the relevant input into a workspace,
processing logic that ascertains an intermediate result in the workspace, and
a decoder that ascertains a final result in the space of the outputs on the basis of the intermediate result.

Examples of neural networks with such an architecture are transformer networks. The space of inputs, on the one hand, and the space of outputs, on the other, are directly interpretable spaces, while the representations in the workspace do not need to have a direct interpretation. The workspace (also referred to as “latent space”) typically has a lower dimensionality than the space of inputs and the space of outputs. The information is, so to speak, forced through a bottleneck (“information bottleneck”).

In this context, the division of the system into several modules, each with its own machine learning model, ensures that the overall “latent space” present is given a structure. If only a single monolithic model were used, said model could “overfit” its training data, i.e., more or less “memorize” these training data without actually internalizing the knowledge contained therein. This would promote a so-called “causal confusion”, inter alia, where the relevant machine learning model provides the correct result, but uses incorrect reasons. For example, a driving assistance system could brake the vehicle as desired in critical situations, but not because it has identified the situation itself as being critical due to the sensor data, but because it has learned to always brake whenever the driver of the vehicle also brakes. The modular design forces the overall system to deal with the “bounding boxes” around objects and the driving lanes on the road as a feature and to draw the right conclusions therefrom.

The main reason for these advantages is in particular that smaller, individual machine learning models are more data-efficient than a large, monolithic machine learning model. This means that, in order to ultimately achieve the same performance in relation to the generated control signal for the at least one actuator, less training data are required. Training three separate modules therefore requires less training data in total than training a monolithic module three times as large.

For example, if dealing with a sequence of perception outputs, said sequence can be used directly for supervised training of the prediction module. For this purpose, previous perception outputs can be supplied to the prediction module as inputs, and it can then be checked to what extent the predictions ascertained then correspond with the later perception outputs.

Furthermore, the individual machine learning models in the respective modules can specialize more strongly on exactly one task. In contrast, a monolithic machine learning model would need to operate more as a generalist.

Finally, it also simplifies the diagnosis in case of any problems. Since the outputs of the perception module, the prediction module, and the planning module are each interpretable, the problem can be narrowed down to one of the modules.

In a further advantageous example embodiment, the prediction module is designed to use intermediate results in the workspace of the perception module when ascertaining its output, and/or the planning module is designed to use intermediate results in the workspace of the prediction module when ascertaining its output. In this way, aspects of the intermediate results can be used that have not yet been changed by translating them back into an interpretable space. However, it is advantageous to also use the output of the perception module or the prediction module in the relevant normal interpretable space of the output. For example, objects in the “latent space” could be upside down or otherwise altered compared to “interpretable spaces.”

In a further particularly advantageous example embodiment, the system is designed to, in response to the fact that an uncertainty of the perception output variable, the prediction output variable and/or the planning output variable resulting from the relevant distribution fulfills a predetermined criterion, bring the vehicle and/or the robot, by controlling it with the control signal, into a state in which the effects of the uncertainty on the operational safety of the vehicle and/or robot are reduced. The state is therefore of such a type that greater uncertainties in the perception output variable, the prediction output variable and/or the planning output variable can be tolerated before operational safety suffers and, for example, a collision of the vehicle and/or robot with other objects is imminent. The degree of uncertainty that is tolerable in this regard depends, in particular, on, for example, the speed of the vehicle and/or robot and the available space up to a possible collision.

The system can, for example, be designed in particular to control the vehicle and/or the robot in response to the uncertainty, such that
the vehicle and/or the robot is moved to a safe position, such as a parking lot or a hard shoulder; and/or
automated operation of the vehicle and/or robot is terminated, for example by stopping the vehicle and/or the robot; and/or
an operator and/or driver of the vehicle and/or robot is requested to take over control.

It is also possible, for example, to reduce the speed of the vehicle and/or robot or to prevent certain dangerous maneuvers, such as passing maneuvers.

The system can in particular be, for example, wholly or partially computer-implemented. The present disclosure therefore also relates to a computer program comprising machine-readable instructions that, when executed on one or more computers and/or compute instances, upgrade the computer(s) and/or compute instance(s) to the above-described system. Compute instances can, for example, be virtual machines, containers, or serverless execution environments, which can be provided in a cloud in particular.

The present disclosure also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present disclosure are explained in more detail below, together with the description of the preferred exemplary embodiments of the present disclosure, with reference to figures.

### BRIEF DESCRIPTION OF THE DRAWINGS

FIG. 1 is an exemplary embodiment of the system 2 for controlling a vehicle and/or robot 1.

FIG. 2, which includes subfigures (a) and (b), shows an exemplary change in the probability densities for the presence of different objects in the detection region of the sensor 4.

FIG. 3 shows an example of processing an image as a sensor signal 5 with the system 2 to form a control signal 6.

### DETAILED DESCRIPTION OF EXAMPLE EMBODIMENTS

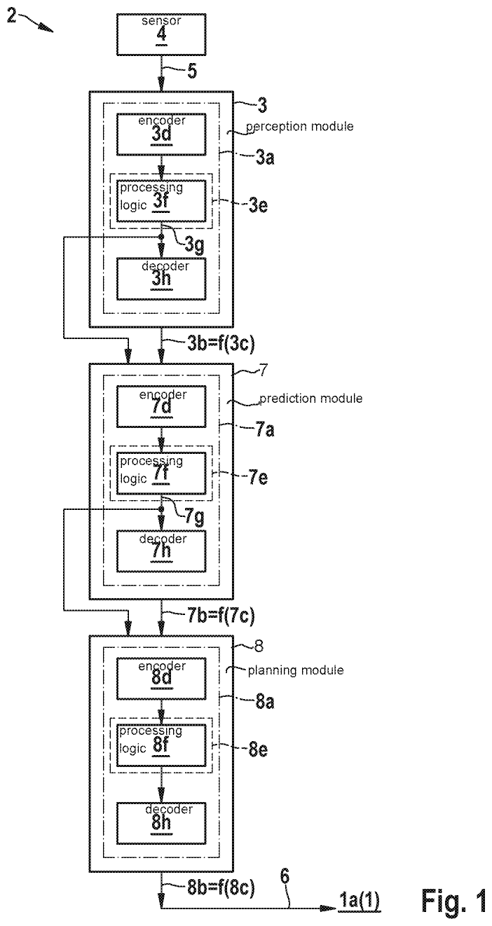

FIG. 1 is a schematic block diagram of an exemplary embodiment of the system 2 for controlling a vehicle and/or robot 1. The system 2 processes sensor signals 5, which were acquired with at least one sensor 4, to form a control signal 6 for at least one actuator la of the vehicle and/or robot 1.

In the example shown in FIG. 1, the system 2 supplies the sensor signals 5 first to a perception module 3. The perception module 3 contains a machine learning model 3a that generates a perception output 3b. Said perception output 3b comprises information that characterizes a distribution of possible values of at least one perception output variable 3c, here designated f (3c). The perception output variable 3c, in turn, describes at least one partial aspect of the current situation that the vehicle and/or the robot 1 is in. In other words, the perception module 3 ascertains a representation of an actual state which the vehicle or the robot 1 is in.

For this purpose, the perception module 3 comprises an encoder 3d, which transfers the sensor signals 5 into a workspace 3e. In the workspace 3e, an intermediate result 3g is generated using processing logic 3f, which is then processed with a decoder 3h to produce the final perception output 3b. The perception output 3b belongs to an interpretable space insofar as it specifies the tangible distribution f (3c) of the perception output variable 3c.

In the example shown in FIG. 1, the perception output 3b is supplied to a prediction module 7. In addition, the prediction module 7 also receives the intermediate result 3g from the workspace 3e of the perception module 3 as an additional input. The prediction module 7 contains a machine learning model 7a that generates a prediction output 7b. Said prediction output 7b comprises information that characterizes a distribution of possible values of at least one prediction output variable 7c, here designated f (7c). The prediction output variable 7c, in turn, describes the further development of at least one partial aspect of the situation that the vehicle and/or the robot 1 is in. In other words, the prediction module 7 ascertains a representation of a future state that the vehicle or the robot 1 will soon be in.

For this purpose, the prediction module 7 comprises an encoder 7d, which transfers the input of the prediction module 7 into a workspace 7e. In the workspace 7e, an intermediate result 7g is generated using processing logic 7f, which is then processed with a decoder 7h to produce the final prediction output 7b. The prediction output 7b belongs to an interpretable space insofar as it specifies the tangible distribution f (7c) of the prediction output variable 7c.

In the example shown in FIG. 1, the prediction output 7b is supplied to a planning module 8. In addition, the planning module 8 also receives the intermediate result 7g from the workspace 7e of the prediction module 7 as an additional input. The planning module 8 contains a machine learning model 8a that generates a planning output 8b. The planning output 8b refers to at least one planning output variable 8c, which in particular may mean, for example, that the planning output 8b comprises information that characterizes a distribution of possible values of the planning output variable 8c. The planning output variable 8c, in turn, describes a desired and/or required future behavior of the vehicle and/or robot 1. In other words, the planning module 8 ascertains a representation of a future action to be performed by the vehicle and/or robot 1.

The system 2 generates the control signal 6 from the planning output 8b, which is supplied to the actuator la of the vehicle and/or robot 1.

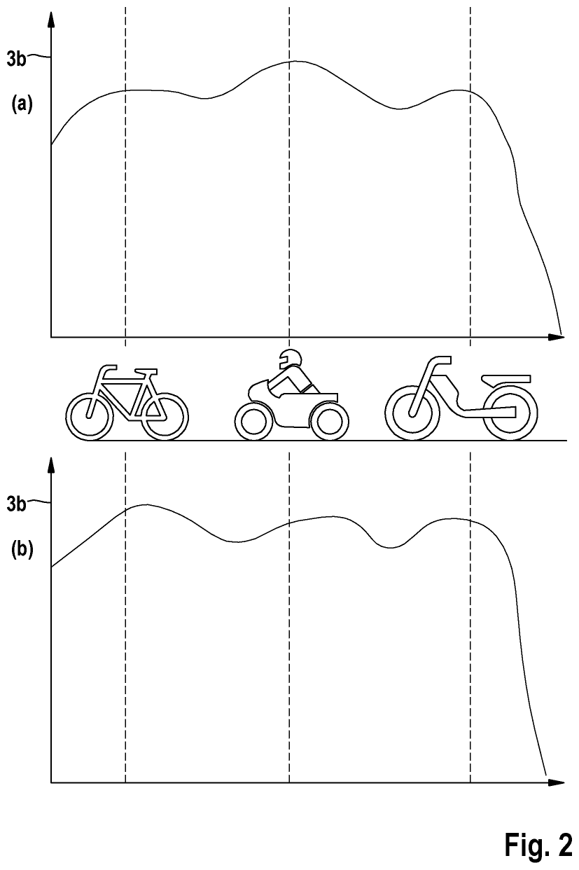

FIG. 2 schematically illustrates the advantage of using a probabilistic perception output 3b over a discrete class to which an identified object belongs. The example shown in FIG. 2 concerns the decision between the classes “bicycle”, “motorcycle” and “moped,” whose silhouettes, symbolized by the corresponding traffic signs, are relatively similar.

Subfigure (a) of FIG. 2 shows the distribution 3b of the probability density for the three classes “bicycle”, “motorcycle” and “moped” in a first state, which is characterized by the sensor signals 5 at a first point in time. The probability density for the “motorcycle” class is slightly larger than the probability density for the “bicycle” class. The probability density for the “moped” class follows in third place, albeit with a slightly greater gap.

Subfigure (a) of FIG. 2 shows the distribution 3b of the probability density for the three classes “bicycle”, “motorcycle” and “moped” in a second state, which is characterized by the sensor signals 5 at a later, second point in time. Here, the probability density for the “bicycle” class is just ahead of the probability density for the “motorcycle” class, while the probability density for the “moped” class is far behind.

If the perception output 3b were the class with the highest probability density, this assignment would change abruptly from “motorcycle” to “bicycle” when switching from the first state according to subfigure (a) of FIG. 2 to the second state according to subfigure (b) of FIG. 2. In contrast, in the system 2 proposed herein, the distribution of the probability density changes gradually. This is much more logical than an abrupt change and also easier to handle mathematically. In particular, this also makes the change distinguishable, which facilitates tracking by backpropagation of gradients.

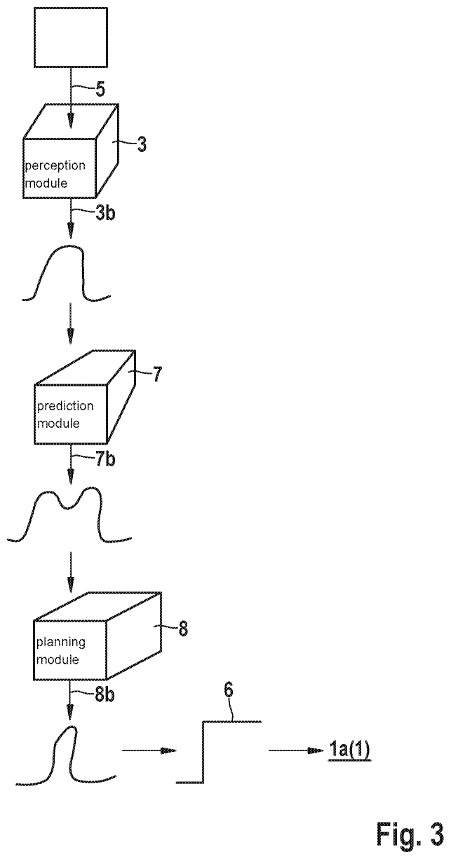

Using an example, FIG. 3 illustrates how a system 2 of the type explained in more detail in FIG. 1 can process an image as a sensor signal 5 in several steps at the level of probability densities to a control signal 6 for the at least one actuator la.

In the example shown in FIG. 3, the probability density provided by the perception module 3 as perception output 3b has a single maximum, which may mean, for example, that, at the present time, an object detected via the sensor signals 5 is likely to belong to exactly a certain class. This probability density 3b is supplied to the prediction module 7. The prediction module 7 ascertains a prediction output 7b, which includes a probability density for the future development of the class assignment. In the example shown in FIG. 3, it can be expected that the class originally most probable according to the perception output 3a will change to one of two adjacent classes.

This expectation is now supplied to the planning module 8. The planning module 8 ascertains, from the situation described by the prediction output 7b, a planning output 8b which corresponds to an action to be performed by the vehicle and/or robot 1.

In the example shown in FIG. 3, the statement of the planning module 8 is: “An evasive maneuver is required in any case, regardless of whether the object is now the one or the other of the most likely classes according to the prediction output 7b.” Accordingly, the planning module 8 generates a planning output 8b, which is converted by the system 2 into a control signal 6 for an evasive maneuver.

1-16. (canceled)

17. A system for controlling a vehicle and/or robot, the system comprising:
at least one perception module configured to process one or more sensor signals, acquired by at least one sensor carried by the vehicle and/or robot, using a trainable or trained machine learning model to produce a perception output;
wherein the system is configured to ascertain a control signal for at least one actuator of the vehicle and/or robot using the perception output, and to control the actuator with the control signal;
wherein the perception output includes information that characterizes a distribution of possible values of at least one perception output variable, and the at least one perception output variable describes at least one partial aspect of a current situation that the vehicle and/or the robot is in.

18. The system according to claim 17, further comprising:
a prediction module to which the perception output is supplied, wherein the prediction module is configured to ascertain a prediction output using a trainable or trained machine learning model, wherein the system is configured to ascertain the control signal using the prediction output;
wherein the prediction output includes information that characterizes a distribution of possible values of at least one prediction output variable, and the at least one prediction output variable describes the further development of at least one partial aspect of the situation that the vehicle and/or the robot is in.

19. The system according to claim 18, further comprising:
a planning module to which the prediction output is supplied, wherein the planning module is configured to ascertain a planning output using a trainable machine learning model;
wherein the system is configured to ascertain the control signal using the planning output; and
wherein the planning output refers to at least one planning output variable that describes a desired and/or required future behavior of the vehicle and/or robot.

20. The system according to claim 19, wherein the planning output includes information that characterizes a distribution of possible values of the planning output variable.

21. The system according to claim 20, wherein the distribution characterized by the information included in at least one of the perception output, the prediction output, or the planning output specifies a probability density for values of the at least one perception output variable, the at least one prediction output variable, or the at least one planning output variable.

22. The system according to claim 21, wherein the probability density is a measure of a probability that an object of a certain class is located in surroundings of the vehicle and/or robot.

23. The system according to claim 20, wherein at least one of the perception output, the prediction output, or the planning output includes parameters of a parameterized distribution.

24. The system according to claim 20, wherein the distribution characterized by the information included in at least one of the perception output, the prediction output, or the planning output, is one of a Gaussian distribution, a Laplace distribution, or a Bernoulli distribution.

25. The system according to claim 20, wherein the information that characterizes the distribution of possible values included in at least one of the perception output, the prediction output, or the planning output, is assigned to at least one object in surroundings of the vehicle and/or robot.

26. The system according to claim 20, wherein each respective module of at least one of the perception module, the prediction module, or the planning module, includes:
an encoder that transfers a respective input of the respective module into a workspace,
processing logic that ascertains an intermediate result in the workspace, and
a decoder that ascertains a final result in a space of an output of the respective module based on the intermediate result.

27. The system according to claim 26, wherein:
the prediction module is configured to use intermediate results in the workspace of the perception module when ascertaining the prediction output of the prediction module, and/or
the planning module is configured to use intermediate results in the workspace of the prediction module when ascertaining the planning output of the planning module.

28. The system according to claim 20, wherein, in response to an uncertainty of at least one of the at least one perception output variable, the at least one prediction output variable, or the at least one planning output variable resulting from the distribution characterized by the information included in at least one of the perception output, the prediction output, or the planning output, fulfilling a predetermined criterion, the system is configured to bring the vehicle and/or the robot, by controlling the vehicle and/or the robot, with the control signal, into a state in which effects of the uncertainty on operational safety of the vehicle and/or robot are reduced.

29. The system according to claim 28, wherein the system is configured to control the vehicle and/or the robot in response to the uncertainty, such that at least one of:
the vehicle and/or the robot is moved to a safe position,
automated operation of the vehicle and/or robot is terminated, or
an operator and/or driver of the vehicle and/or robot is requested to take over control.

30. A non-transitory machine-readable data carrier on which are stored machine-readable instructions that, when executed on one or more computers and/or compute instances, upgrade the one or more computers and/or compute instances to a system for controlling a vehicle and/or robot, the system comprising:
at least one perception module configured to process one or more sensor signals, acquired by at least one sensor carried by the vehicle and/or robot, using a trainable or trained machine learning model to produce a perception output;
wherein the system is configured to ascertain a control signal for at least one actuator of the vehicle and/or robot using the perception output, and to control the actuator with the control signal;
wherein the perception output includes information that characterizes a distribution of possible values of at least one perception output variable, and the at least one perception output variable describes at least one partial aspect of a current situation that the vehicle and/or the robot is in.

31. One or more computers comprising a non-transitory machine-readable data carrier on which are stored machine-readable instructions that, when executed on one or more computers and/or compute instances, upgrade the one or more computers to a system for controlling a vehicle and/or robot, the system comprising:
at least one perception module configured to process one or more sensor signals, acquired by at least one sensor carried by the vehicle and/or robot, using a trainable or trained machine learning model to produce a perception output;
wherein the system is configured to ascertain a control signal for at least one actuator of the vehicle and/or robot using the perception output, and to control the actuator with the control signal;
wherein the perception output includes information that characterizes a distribution of possible values of at least one perception output variable, and the at least one perception output variable describes at least one partial aspect of a current situation that the vehicle and/or the robot is in.
